(19) United States
(12) Patent Application Publication
(10) Pub. No.: US 2011/0278854 A1
(43) Pub. Date: Nov. 17, 2011

(54) POWER GENERATION SYSTEM

(76) Inventors: Chin-Hui Chiang, Taipei (TW); Hsin-Jung Chiang, Taipei (TW)

(21) Appl. No.: 12/777,557

(22) Filed: May 11, 2010

(51) Int. Cl. H02K 7/116; F03G 7/10

(52) U.S. Cl. 290/1 C; 74/DIG. 9

(57) ABSTRACT

A power generation system includes a base, a loading driving unit, and an adjusting unit. The base includes a sidewall. The load driving unit includes a platform, a first gear, a second gear, a roller, a motor, a first connection member and a second connection member. One end of the platform of the load driving unit is pivotally connected with the sidewall of the base. A heavy load is disposed on the platform. The loading driving unit applies a force on the first gear and then generates a moment of force to the second gear. A kinetic energy output from the motor is transferred from the first gear to the second gear. Due to the kinetic energy and the moment of force, the second gear has an output power greater than the input power that is transferred from the motor.

### BACKGROUND OF THE INVENTION

1. Field of the Invention

The present invention relates generally to a power generation system, and more particularly, to a power generation system using gravity for improving efficiency.

2. The Prior Arts

Generation of electric power is generally categorized into hydraulic power generation, thermal power generation, wind power generation, solar power generation, and nuclear power generation. However, all of these power generation methods have disadvantages. For example, a hydraulic power station requires a very high construction cost, and must be built in accordance with specific geographical conditions. A thermal power station not only requires a very high construction cost, but also produces a great amount of exhaust and pollution, and consumes a lot of fossil fuels. Although wind power generation is known as featured with lower construction cost, it is likely to be affected by the weather conditions and can produce only small amount of electric power. Solar power generation has the advantages of low cost and environmental friendly. However, the solar power generation is often restricted by the weather condition and can produce only small amount of electric power. As to the nuclear power generation, it is adapted for generating a large quantity of electric power. Unfortunately, the construction cost of a nuclear power station is very high, and the nuclear waste has to be very carefully dealt with.

Further, it is estimated that the petroleum resource of the world would be exhausted in 50 years, and people have to find out replacement energy for substitution. For example, the hybrid vehicles and the solar cells are developed under such a crisis background. However, most of the proposed replacement energy resources use electric power for substituting the petroleum resource. Unfortunately, in accordance of all of the aforementioned power generation approaches, the efficiency of power conversion (i.e., output electric energy/input solar energy) can only achieve 30% to 40%, and most of the energy is lost in the form of heat.

### SUMMARY OF THE INVENTION

A primary objective of the present invention is to provide a power generation system, which overcome the foregoing disadvantages of the conventional power generation systems that have poor conversion efficiency and high cost.

According to the present invention, the gravity is introduced for applying a sustaining moment of force to facilitate a gear set that drives a power generator. In such a way, an enlarged transmission force is obtained for generating more electric power.

For achieving the foregoing objective, a power generation system according to an embodiment of the present invention includes a base, a loading driving unit, and a power generator. The base includes a sidewall. The load driving unit includes a platform, at least one first gear, a second gear, at least one roller, a motor, a first connection member and a second connection member. One end of the platform of the load driving unit is pivotally connected with the sidewall of the base. A heavy load is provided on the platform. The roller and the first gear are pivotally coupled to a bottom of the platform, and the motor is disposed under the platform. The motor is connected via the first connection member to the first gear for driving the first gear to rotate. The second gear is pivotally coupled to the base. The second gear is meshed with the first gear at a position deviate from plumb lines of both of the first gear and the second gear. The second gear is coupled via the second connection member to the power generator. The releasing unit is disposed on the base and is adapted for supporting the roller and/or releasing the roller. The motor is adapted for driving the first gear and the first gear applies a sustaining moment of force to the second gear. The second gear then drives the power generator for generating electric power greater than the power inputted from the motor.

According to another embodiment of the present invention, the power generation system further includes an adjusting unit. The adjusting unit is disposed on the base. The adjusting unit includes an operation device (e.g., a hydraulic cylinder) disposed on the base, and a cable connected between the platform and the base. The operation device is adapted for pulling the cable for moving the platform. Then, the platform can apply a downward force.

According to a further embodiment of the present invention, there are two rollers and one first gear disposed under the platform. The two rollers and the first gear provide three co-plane points defining a plane.

According to a still further embodiment of the present invention, the releasing unit includes a supporting bar controlled by an operation apparatus. The operation apparatus controls the supporting bar to provide a support to the rollers or not. When the support provided to the rollers is relieved, the platform releases its force of gravity to apply a moment of force to the second gear via the first gear.

According to a furthermore embodiment of the present invention, a line connecting a center of the first gear and a center of the second gear is defined as a center connection line. An included angle defined between the center connection line and a vertical line of the second gear can be adjusted within a range from 5 to 90 degrees.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an perspective view of a power generation system according to an embodiment of the present invention;

FIG. 2 is a side view of the power generation system according to the present invention;

FIG. 3 illustrates a moment of force applied by a first gear to a second gear of a load driving unit;

FIG. 4A is a schematic diagram illustrating the power generation system in a status that a roller is not released by the releasing unit;

FIG. 4B is a schematic diagram illustrating the power generation system in a status that the roller is released by the releasing unit; and

FIG. 5 illustrates the operation of adjusting the load of the platform with the adjusting unit according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

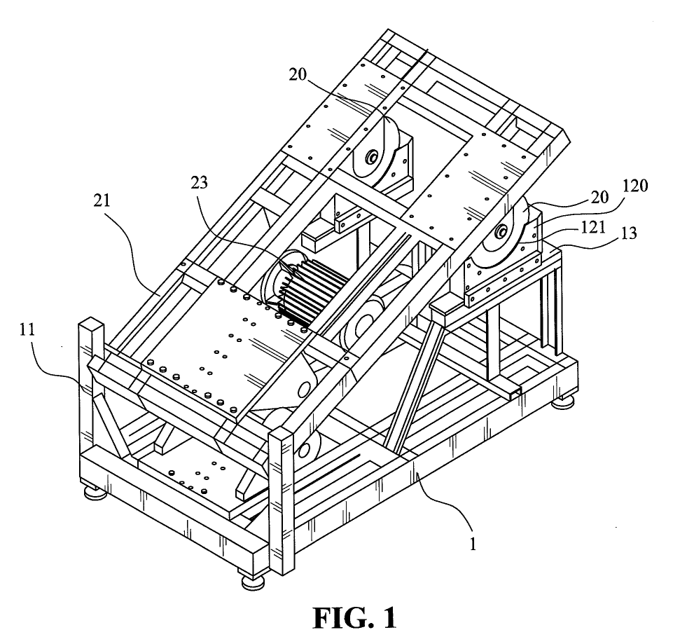

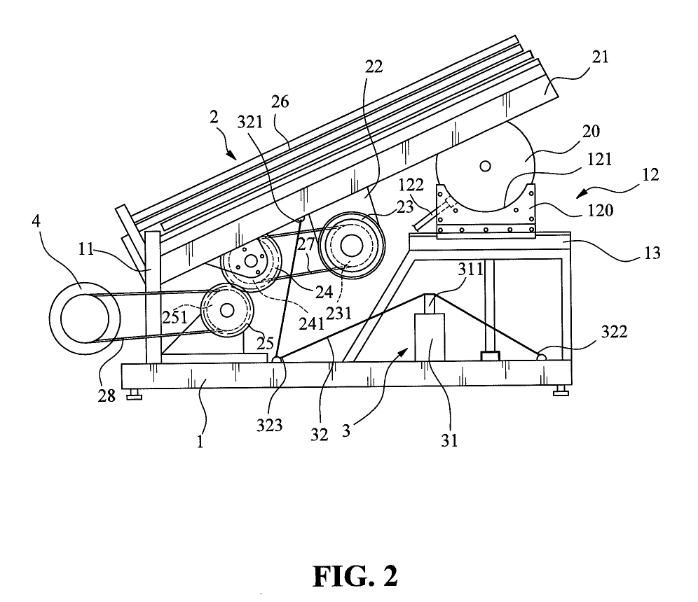

Referring to FIGS. 1 and 2, a power generation system according to an embodiment of the present invention includes a base 1, a loading driving unit 2, a releasing unit 12, an adjusting unit 3 and a power generator 4.

The base 1 includes a sidewall 11 configured uprightly extending up from one end of the base 1. The releasing unit 12 is disposed on another end of the base 1 opposite to the sidewall 11 of the base 1.

The load driving unit 2 includes a platform 21, at least one first gear 24, a second gear 25, a releasing unit 12, two rollers 20, a motor 23, a first connection member 27 and a second connection member 28.

The platform 21 is made of section steel and configured as a steel structure. A pivotal end of the platform 21 is pivotally connected with the sidewall 11 of the base 1 and the other end of the platform is a free end. A heavy load 26, such as steel bars and metal ingots, is provided on the platform 21. The first gear 24 is pivotally coupled to a bottom of the platform 21 at a position adjacent to the pivotal end of the platform 21. The two rollers 20 are pivotally coupled to the bottom of the platform 21 at a position adjacent to the free end. The platform 21 further includes a protrusion board 22 protruded out from the bottom of the platform 21, and the motor 23 is disposed on the protrusion board 22. An output shaft of the motor 23 is adapted to drive a driving wheel 231 to rotate. A first driven wheel 241 is concentric with the first gear 24. The first connection member 27 connects the driving wheel 231 with the first driven wheel 241. As such, when the motor 23 is running, the motor 23 drives the driving wheel 231 to rotate. The driving wheel 231 then drives the first driven wheel 241 to rotate through the first connection member 27. Meanwhile, the first driven wheel 241 also carries the first gear 24 to rotate. Preferably, the driving wheel 231 and the first driven wheel 241 are belt pulleys, and the first connection member 27 is a driving belt adapted for transmitting a driving force between the belt pulleys. Alternatively, the driving wheel 231 and the first driven wheel 241 may also be chain wheels, and the first connection member 27 is a drive chain adapted for transmitting a driving force between the chain wheels. Further, the power generation system according to the preferred embodiment has two rollers 20 and one first gear 24, which provide three co-plane points defining a plane.

The second gear 25 is movably connected to the base 1. The second gear 25 includes a second driven wheel 251 concentrically configured therewith. The second connection member 28 connects the second driven wheel 251 with a wheel of the power generator 4. The second driven wheel 251 and the wheel of the power generator 4 are belt pulleys or chain wheels, and the second connection member 28 is a corresponding belt or chain. The second gear 25 meshes with the first gear 24 at a position deviate from plumb lines of both of the first gear 24 and the second gear 25. In other words, a line connecting a center of the first gear 24 and a center of the second gear 25 is defined as a center connection line. An included angle θ defined between the center connection line and a vertical line of the second gear 25 is preferably ranged from 5 to 90 degrees.

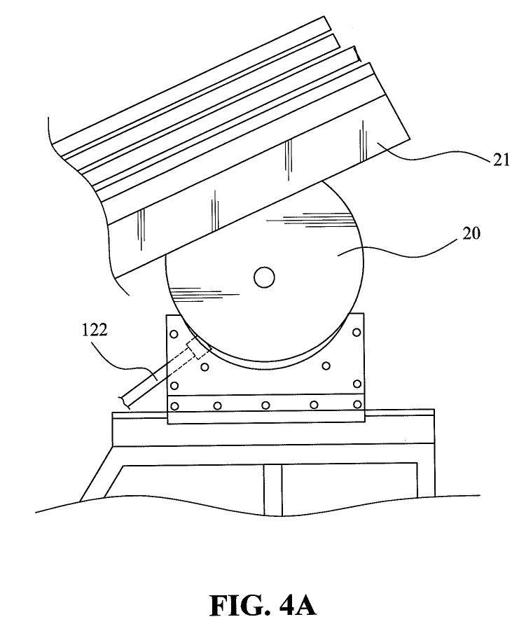

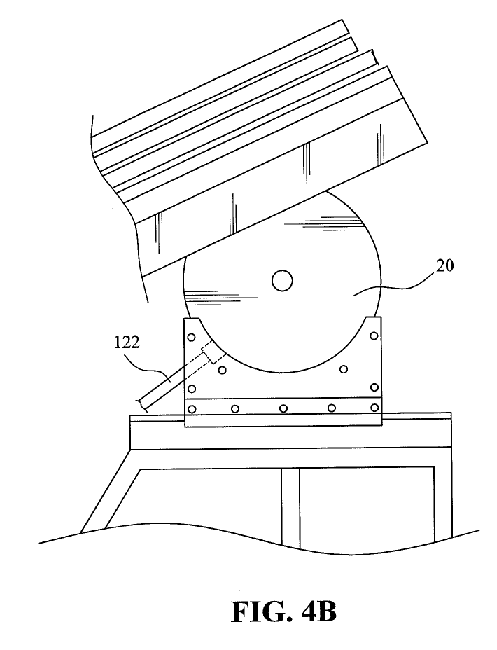

The releasing unit 12 includes a table 13 disposed on the base 1 and a supporter 120 disposed on the table 13. The supporter 120 is configured with a curved slot 121 to receive a part of the roller 20. The supporter 120 further includes a supporting bar 122. The supporting bar 122 is coupled to an operation apparatus (e.g., a hydraulic cylinder; not shown in the drawings). The operation apparatus is adapted to operate the supporting bar 122 to protrude out for supporting the roller 20 as shown in FIG. 4A, or withdraw for releasing the roller 20 as shown in FIG. 4B.

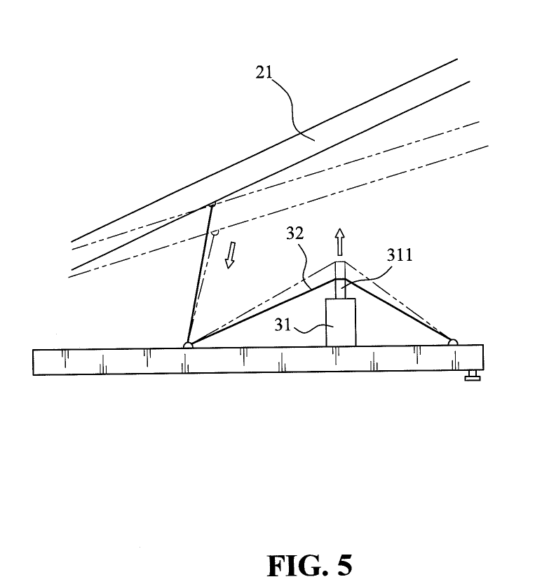

The adjusting unit 3 includes an operation device 31 disposed on the base 1, and a cable 32 connected between the platform 21 and the base 1. The cable 32 has a first end 321 fixed to the bottom of the platform 21 and a second end 322 fixed to the base 1 at a position relatively apart from the sidewall 11. A middle section 323 of the cable 32 is fixed to the base 1 at a position relatively adjacent to the sidewall 11. The operation device 31 is preferred to be a hydraulic cylinder. An operation portion 311 of the operation device 31 is adapted for applying a force to the cable 31 for tensioning the cable 32. Referring to FIG. 5, when the operation portion 311 protrudes out, the cable 32 is tensioned so as to pull the platform 21 to swing downward, and thus the first gear 24 applies a force onto the second gear 25.

In operation, the motor 23 drives the first gear 24 to rotate. Then, the first gear 24 drives the second gear 25 to rotate. At the same time, the first gear 24 also applies a sustaining moment of force onto the second gear 25. In such a way, the second gear 25 has an output power greater than the power inputted by the motor 23 for driving the power generator 4 to generate electric power.

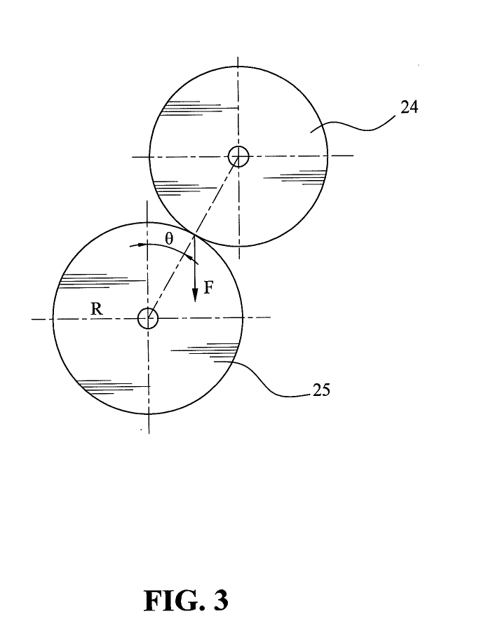

As shown in FIG. 3, assume in a condition that the first gear 24 meshes with the second gear 25, the included angle θ defined between the center connection line and a vertical line of the second gear 25 is 30 degrees, the heavy load 26 and the platform 21 indirectly apply a force F onto the second gear 25, the force F is equal to 10,000 kgf, and R is the radius of the second gear 25. The force F generates a sustaining moment of force onto the second gear 25, where the moment of force is equal to 10,000 kgf×sin 30°×R. In other words, a kinetic energy is transferred from the motor 23 to the first gear 24, and then the kinetic energy is transferred from the first gear 24 to the second gear 25. In addition to the kinetic energy transferred from the first gear 24, a sustaining moment of force is also applied to the second gear 25. Therefore, the second gear 25 has an output power (the kinetic energy and the moment of force) greater than the input power (the kinetic energy from the motor 23), so as to facilitate the power generator 4 to obtain a higher power generation efficiency.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A power generation system, comprising:
a base comprising a sidewall upwardly extending from one end of the base;
a load driving unit comprising:
a platform having a pivotal end pivotally connected with the sidewall of the base and a free end, a heavy load being disposed on the platform 21;
at least one first gear, at least one roller and a motor pivotally connected with the platform;
a second gear pivotally connected with the base and meshed with the first gear at a position deviate from plumb lines of both of the first gear and the second gear;
a releasing unit disposed on the base and adapted for supporting the roller or releasing the roller;
a first connection member connecting the first gear with the motor for transmitting a driving force from the motor to the first gear; and
a second connection member connecting the second gear with a power generator; and
an adjusting unit comprising:
an operation device disposed on the base; and
a cable connected between the platform and the base, wherein the operation device is adapted to apply a force to the cable so as to move the platform.

2. The power generation system as claimed in claim 1, wherein the loading driving unit comprises two rollers and one first gear disposed under the platform, and the two rollers and the first gear provide three co-plane points defining a plane.

3. The power generation system as claimed in claim 1, wherein the operation device of the adjusting unit is a hydraulic cylinder and the operation device connected with the cable for applying a force to the cable.

4. The power generation system as claimed in claim 1, wherein the releasing unit comprises a supporting bar controlled by an operation apparatus for controlling to provide a support to the roller or not to provide the support.

5. The power generation system as claimed in claim 1, wherein a line connecting a center of the first gear and a center of the second gear is defined as a center connection line, and an included angle defined between the center connection line and a vertical line of the second gear is ranged from 5 to 90 degrees.
